(19) United States
(12) Patent Application Publication
(10) Pub. No.: US 2008/0102346 A1
(43) Pub. Date: May 1, 2008

(54) Current collector plate

(76) Inventors: Kenneth Smith, Colfax, WI (US); Justin Loew, Wausau, WI (US); Roger Albertson, Mathis, TX (US)

Correspondence Address: Justin Loew, 1022 Stark Street, Wausau, WI, 54403, US

(21) Appl. No.: 11/586,955

(22) Filed: Oct. 27, 2006

(51) Int. Cl. H01M 8/02; B32B 3/10; B32B 3/00

(52) U.S. Cl. 429/38; 428/131; 428/156

(57) ABSTRACT

Disclosed is a new conductive current collector plate. The plate has alternating concentric ridges and channels on one side and a series of holes drilled perpendicular to and through the diameter of the concentric ridges. Two plates used in combination as the cathode and anode side of a typical proton exchange membrane (PEM) fuel cell distribute fuel or oxidant evenly across the membrane and does not require the use of a manifold.

### FIELD OF THE INVENTION

The invention relates to fuel cells and more specifically the structure that comprises the housing of a fuel cell.

### DISCUSSION OF THE PRIOR ART

Fuel cells are documented extensively in the prior art. In particular, patents U.S. Pat. No. 6,245,453 to Iwase, et al., Jul. 12, 2001 and U.S. Pat. No. 7,097,931 to Abdou, et al., Aug. 29, 2006 describe novel methods for distributing fuel across a proton exchange membrane (PEM). The distribution is accomplished by “lands” or “pins” protruding from the substantially planar surface of the plate. The patents also describe manifolds for the introduction and removal of fuels and oxidants. While these prior inventions may achieve improved fuel and oxidant distribution across the proton exchange membrane of a fuel cell they are unnecessarily complicated and difficult to manufacture.

### OBJECTS AND ADVANTAGES

The primary advantage of the new current collector plate is that it does not require a manifold to distribute fuel or oxidant over the proton exchange membrane of a fuel cell, and thus is simpler, easier, and cheaper to manufacture. The alternating concentric channels and ridges combined with a series of holes drilled perpendicular to and through the diameter of the new current collector plate replace the supply manifold, exhaust manifold, lands, orifices, and diagonal channels of the prior art.

A secondary advantage of the new current collector plate is the structural integrity of the concentric design.

A third advantage of the new current collector plate is that it can be easily manufactured on conventional milling equipment.

### SUMMARY

The new current collector plate is a device constructed of any electrically conductive material. It is substantially planar with alternating concentric ridges and channels on one side. A series of holes drilled through the diameter and perpendicular to the plane of the ridges serve to distribute fuel or oxidant across the proton exchange membrane of a fuel cell. A pair of new current collector plates can serve as the anode and cathode side of a PEM fuel cell.

### DESCRIPTION OF THE DRAWINGS

FIG. 1 is a top view of the new current collector plate.

FIG. 2 is a side view of the new current collector plate.

### DETAILED DESCRIPTION OF THE INVENTION

### Description of the Preferred Embodiment

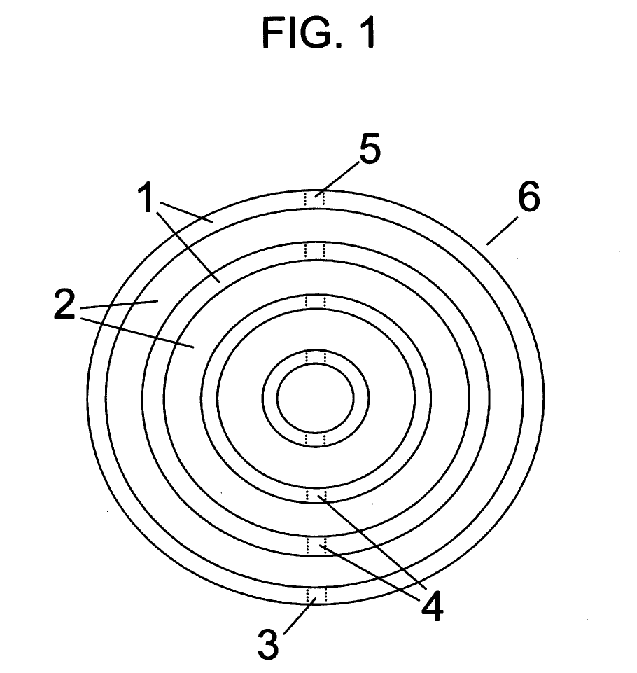

Referring to FIG. 1, the preferred embodiment is a substantially planar circular plate of conductive material 6 (hereafter referred to as “current collector plate”) with alternating concentric ridges 1 and channels 2 on one side. Drilled perpendicular to the concentric ridges 1 and through the diameter of the current collector plate 6 is a series of holes 4 that serve to distribute fuel or oxidant across the proton exchange membrane of a fuel cell. The first in the series of holes 4 serves as the inlet 3 for fuel or oxidants. The last in the series of holes 4 on the opposite side of the current collector plate 6 serves as the outlet 5 for by-products.

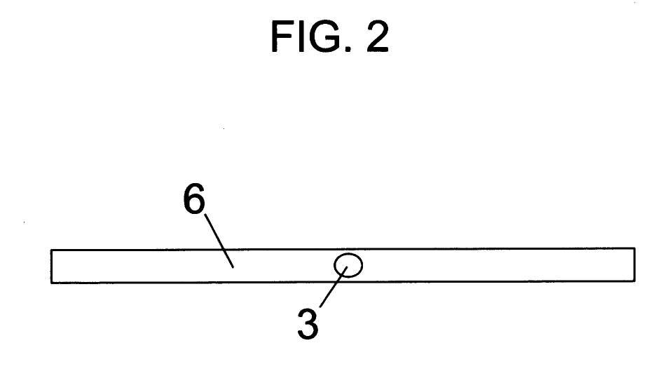

Referring to FIG. 2, the current collector plate 6 is depicted on a side view showing the inlet 3 for fuel or oxidant.

### Operation of the Preferred Embodiment

When in operation, two identical new current collector plates 6 are placed together with the alternating concentric ridges 1 and channels 2 facing each other and a proton exchange membrane in between. The two current collector plates 6 serve as the anode and cathode side of a typical proton exchange membrane fuel cell. As fuel or oxidant is introduced through the inlet 3 it follows the path of each concentric channel 2 thus being distributed substantially evenly across the proton exchange membrane. By-products exit through the outlet 5.

### Description of a Second Embodiment

The second embodiment is identical to the first embodiment except that the material from which it is constructed is any non-conductive material. This material is then coated with an electrically conductive material to allow normal operation of the PEM fuel cell.

### Conclusion and Scope

From the preceding description the reader will understand that the new current collector plate is structurally sound, easy to manufacture, and substantially simpler than the prior art. The preferred embodiment is a circular plate with concentric ridges and channels, however it will be immediately obvious to those skilled in the art that any concentric polygon shape could be used to obtain the same simple fuel distribution and structural integrity. Furthermore, more than one series of holes could be drilled through the diameter of the concentric ridges. These modifications and others will be apparent to those skilled in the art. Thus, the scope of the invention is not to be limited by the specification and is rather to be determined by the appended claims.

### LIST OF REFERENCE NUMERALS

1.—Ridge of conductive material

2.—Fuel or oxidant channel

3.—Fuel or oxidant inlet

4.—Series of holes

5.—By-product outlet

6.—Conductive current collector plate

What is claimed is:

1. A substantially planar conductive plate having alternating concentric ridges and channels extending away from one side and a series of holes through the diameter and perpendicular to said concentric ridges.

2. A substantially planar plate coated with a conductive material having alternating concentric ridges and channels extending away from one side and a series of holes through the diameter and perpendicular to said concentric ridges.
